(19) United States
(12) Patent Application Publication
(10) Pub. No.: US 2009/0155507 A1
(43) Pub. Date: Jun. 18, 2009

(54) AIR SEALING BODY AND A CHECK VALVE DEVICE THEREOF CAPABLE OF INTENSIFYING AIR-TIGHTNESS

(76) Inventors: YAW-SHIN LIAO, Sindian (TW); Yaw-Chuan Liao, Sindian (TW); Chien-Hua Liao, Sindian (TW)

Correspondence Address: G. LINK CO., LTD., 3550 BELL ROAD, MINOOKA, IL, 60447, US

(21) Appl. No.: 11/956,882

(22) Filed: Dec. 14, 2007

(51) Int. Cl. B32B 1/06; F16K 15/00

(52) U.S. Cl. 428/35.2; 137/511

(57) ABSTRACT

An air sealing body capable of intensifying air-tightness comprises two outer membranes and two inner membranes. At least a heat resistant section is formed between the inner membranes by means of coated heat resistant material. Four sides of the two outer membranes are thermally sealed and an air filling passage, an air inlet and an air column are thermally formed to across the heat resistant section. The heat resistant section is further thermally sealed with the thermal seal spots. Hence, a structure with the air inlet being forcedly opened during air being filled is constituted and a curved surface zone is formed at the air column near the air filling side. Multiple wrinkles are produced between the inner membranes. A column zone is disposed at a side of the curved surface zone. At least a ring-shaped thermal seal line is attached to at least the inner membranes and disposed next to the column surface zone and outside the curved surface zone. At least a second inlet is thermally formed between the inner membranes and disposed at the intersection of the heat resistant section and the ring-shaped thermal seal line to communicate both sides of the thermal seal line. The inner membranes is attached to one of the outer membranes after the air being filled with the wrinkles being interrupted by the thermal seal line of the second inlet to perform blocking the air effectively.

### BACKGROUND OF THE INVENTION

1. Field of the Invention

The present invention is related to an air sealing body and a check valve device thereof and particularly to an air sealing body and a check valve device capable of intensifying effect of air-tightness.

2. Brief Description of the Related Art

The conventional way for protecting articles from damage caused by shock is to pack the articles with the air bulb papers for absorbing the shock from the articles and offering the articles a cushion. However, the air bulb papers provide limited shock absorbing capability only and are unable to stand greater impact. Therefore, an air packing bag, which is made of resin film, was developed instead of the air bulb papers.

Referring to FIGS. 1A and 1B, the air packing bag provides two outer membranes A161, A162, which are made of resin, to constitute a sealing body for filling air. An air valve A14 is mounted between the outer membranes A161, A162 to allow an upper air valve membrane A141 and a lower air valve membrane A142 joining to each other such that an air path A143 is formed between the air valve membranes A141, A142. While the air is filled, the air enters the air chamber A13 via the air path A143 to expand the air chamber A13. The air in the air chamber A13 is capable of pressing the upper and lower air valve membranes A141, A142 such that the air filling can be stopped automatically. However, the prior art is impossible to prevent the air from flowing inversely via the air path A143 and it results in the air packing bag A10 is unable to keep the air inside for a long period of time.

Referring to FIGS. 2A and 2B in company with FIGS. 1A and 1B, the upper valve membrane A141 and the lower valve membrane A142 are touched to each other and then thermally joined to the outer membrane A162 to allow the air valve A14 being able to adhere the outer membrane A162. The air path A143 is thermally sealed with guide parts A144, A145, A146 and A147 to guide the air moving toward the air chamber A13 and to prevent the air from flowing inversely via the air path A143. The preceding structure is disclosed in Taiwan Utility Model Publication No. 587049 entitled “ASSEMBLING STRUCTURE OF A VALVE OF A SEALING BODY AND A FABRICATING DEVICE FOR A SEALING BODY WITH A VALVE”.

Referring to FIG. 3, the air packing bag A10 has a cylindrical shape after the air is filled such that the upper air valve membrane A141 and the lower air valve membrane A142 are unable to adhere the outer membrane A161 completely and a wrinkle part A148 being formed at the upper air valve membrane A141 and the lower air valve membrane A142 causes the air in the air chamber A13 to leak inversely via the wrinkle part A148. As a result, the air packing bag A10 is unable to provide the function of cushion.

### SUMMARY OF THE INVENTION

In order to overcome deficiencies of the preceding prior art, an object of the present invention is to provide an air sealing body and a check valve device with which air-tightness can be intensified and air leakage can be avoided.

Accordingly, an air sealing body capable of intensifying air-tightness according to the present invention includes two outer membranes; two inner membranes with adhesive agent being slightly coated on one of the inner membranes for adhering the two inner membranes to each other, being disposed between the two outer membranes and being thermally joined to the outer membranes respectively with a heat resistant material being coated on the inner side of the respective inner membrane to form a heat resistant section; at least an air column being thermally formed between the outer membranes for air storage; an air filling passage being disposed next to the air column; at least a thermal seal spot to allow the inner members at the air filling passage being forcedly detached while the outer membranes expanding at the time of air filling such that the air inlet at the heat resistant section is capable of opening; at least a first inlet being formed between said inner membranes and at the thermal seal line crossing the heat resistant section due to the heat resistant section allowing said inner membranes not adhering to each other and providing an opening for admitting the air; a curved surface zone being disposed on the air column next to the air filling passage for the air in the air column pressing the inner membranes to adhere one of the outer membranes such that a plurality of wrinkles are produced between said inner membranes; a column surface zone being disposed next to said curved surface zone for the air in the air column pressing the inner membranes to adhere one of the outer membranes flatly; at least a ring-shaped thermal seal line being thermally formed to join to the inner membranes through the heat resistant section and being disposed at the curved surface zone next to the column surface zone; and at least a second inlet being thermally formed between the inner membranes through the heat resistant section and being disposed at an intersection of said heat resistant section and said ring-shaped thermal seal line for communicating the lower portion and the upper portion of the air column.

Further, a check valve device capable of intensifying air-tightness according to the present invention is mounted to at least an air column, which is formed by means of thermally sealing two outer membranes, and an air filling passage is disposed at a lateral side of the air column for the air being able to be filled into and expand the air column and the check valve device includes two inner membranes, at least a first inlet, a curved surface zone, a column surface zone, at least a ring-shaped thermal seal line and at least a second inlet. The two inner membranes with a heat resistant material being coated in between are disposed between the two outer membranes. The outer sides of the inner membranes are thermally sealed to the outer membranes via at least a thermal spot and the inner sides of the inner membranes are kept without joining to each other. The first inlet is thermally formed between the inner membranes and the thermal spot can forcedly detach the inner membranes from each other at the time of air filling to allow the first inlet opening automatically. The air passes through the first inlet and enters the air column. The curved surface zone is disposed on the air column next to the air filling passage for the air in the air column being able to urge the inner membranes to adhere one of the outer membranes such that a plurality of wrinkles are produced between the inner membranes. The column surface zone is disposed next to the curved surface zone for the air in the air column being able to urge the inner membranes to adhere one of said outer membranes flatly. The ring-shaped thermal seal line is thermally formed with the heat resistant section and crossing the inner membranes and is located at the curved surface zone next to the column surface zone. The second inlet is thermally formed with the heat resistant section between the inner membranes and is disposed at a position of the heat resistant material intersecting the ring-shaped thermal seal line for the lower portion of the air column being able to communicate with and the upper portion of the air column.

Further, an air sealing body capable of intensifying air-tightness and a check valve device thereof according to the present invention is capable of expanding the air filling passage and detaching the two inner membranes from each other while the air being filled due to a heat resistant material being disposed between the inner membranes and thermally forming the thermal spot at the outer membranes such that the first inlet between the two inner membranes opens automatically during the outer membranes detaching the inner membranes due to the coated heat resistant material being free from thermal sealing. When the air passes through the first inlet to flow between the inner membranes and allows the second inlet to open automatically for the air entering the air column to expand the air column after the air passes through the second inlet. Once the air column fully expands, the air in the air column urges the inner membranes to adhere one of the outer membranes. The inner membranes at the curved surface zone form a plurality of wrinkles and at the column surface zone keep adhering to one of the outer membranes flatly. Meanwhile, the air in the air column urges the inner membranes to shut the second inlet and block the air flowing into or outward the air column such that the air leaking outward is prevented and effect of air-tightness can be enhanced. Hence, the problems of the conventional air packing bag such as the air leaking outward via the wrinkles at the time of air filling, losing function of cushion and being unable to keep in good condition for a long period of time can be overcome completely such that the air sealing body of the present invention is capable of providing longer life span unless damage is resulted from subjecting to foreign force improperly.

### BRIEF DESCRIPTION OF THE DRAWINGS

The detail structure, the applied principle, the function and the effectiveness of the present invention can be more fully understood with reference to the following description and accompanying drawings, in which:

FIG. 1A is a perspective view of the conventional air packing bag before being filled with air;

FIG. 1B is a perspective view of the conventional air packing bag after being filled with air;

FIG. 2A is a fragmentary perspective view of another conventional packing bag;

FIG. 2B is a fragmentary sectional view of the conventional packing bag shown in FIG. 2A;

FIG. 3 is a cross section view of a further conventional air packing bag;

FIG. 4A is a plan view illustrating the first embodiment of an air packing bag according to the present invention before being filled with air;

FIG. 4B is a sectional view illustrating the first embodiment of an air packing bag after being filled with air and showing the process and the structure of the inner membranes touching the inner wall surface of the packing bag;

FIG. 5A is a plan view illustrating the second embodiment of an air packing bag according to the present invention before being filled with air;

FIG. 5B is a sectional view illustrating the first embodiment of an air packing bag after being filled with air and showing the inner membranes being disposed at the middle of the packing bag;

FIG. 6A is a plan view illustrating the third embodiment of an air packing bag according to the present invention before being filled with air;

FIG. 6B is a sectional view illustrating the third embodiment of an air packing bag after being filled with air and showing the process and the structure of the single inner membrane touching the inner wall surface of the packing bag;

FIG. 7 is a sectional view illustrating the fourth embodiment of an air sealing body according to the present invention showing the process to form the air collecting well and the structure thereof;

FIG. 8A is a plan view illustrating the fifth embodiment of an air packing bag according to the present invention before being filled with air;

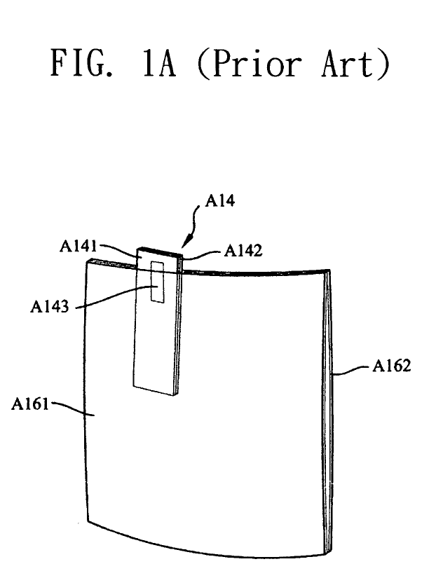

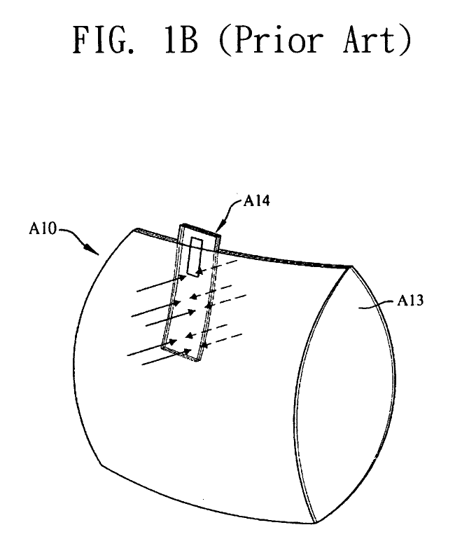

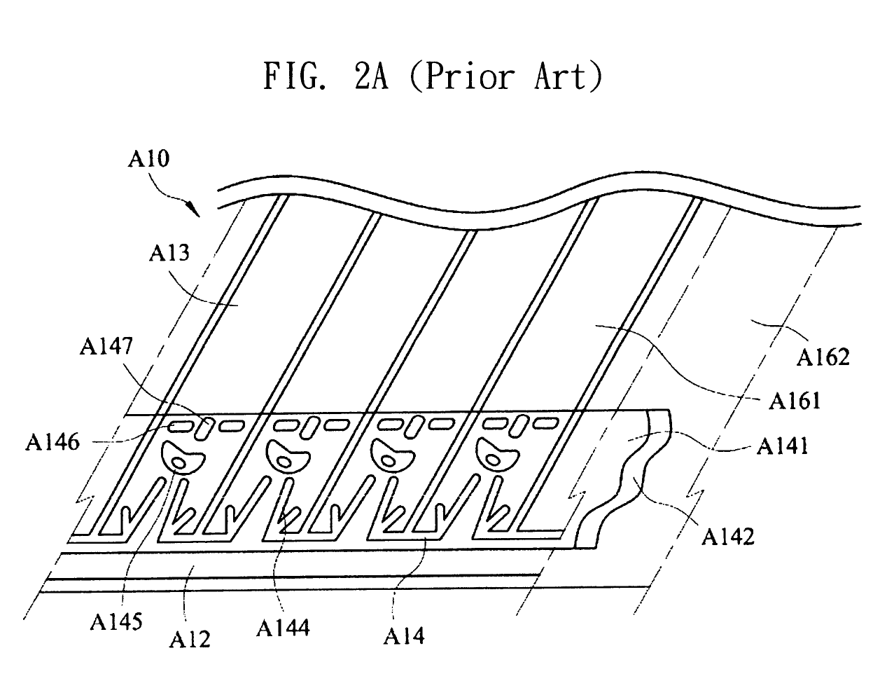

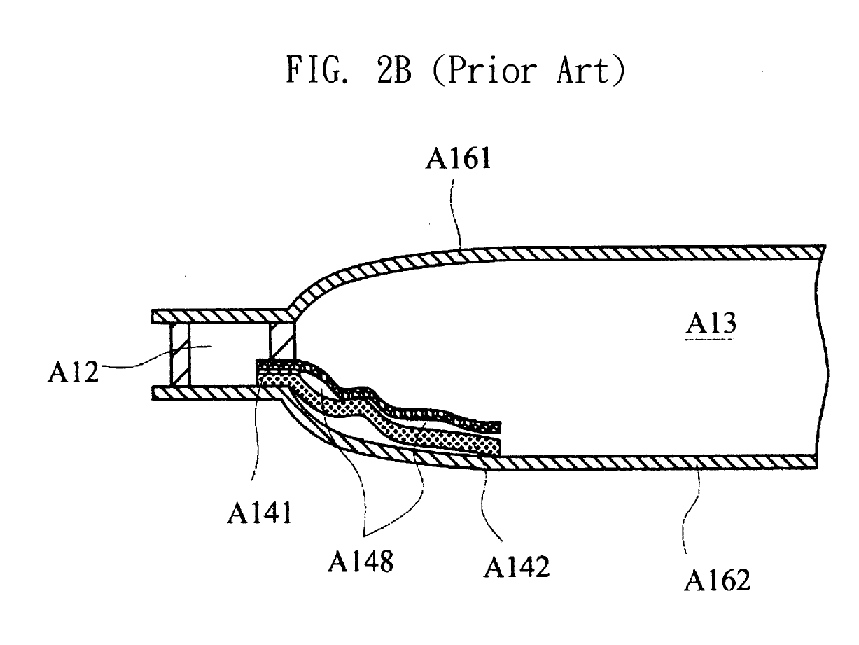

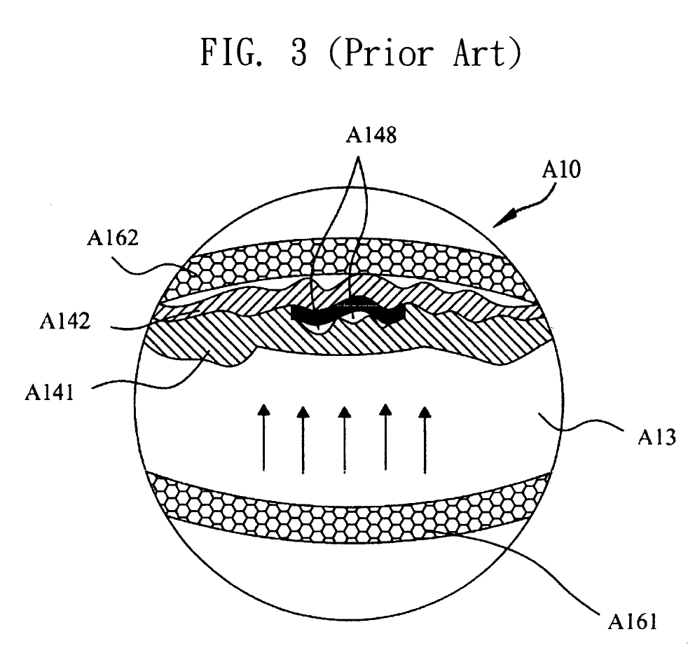

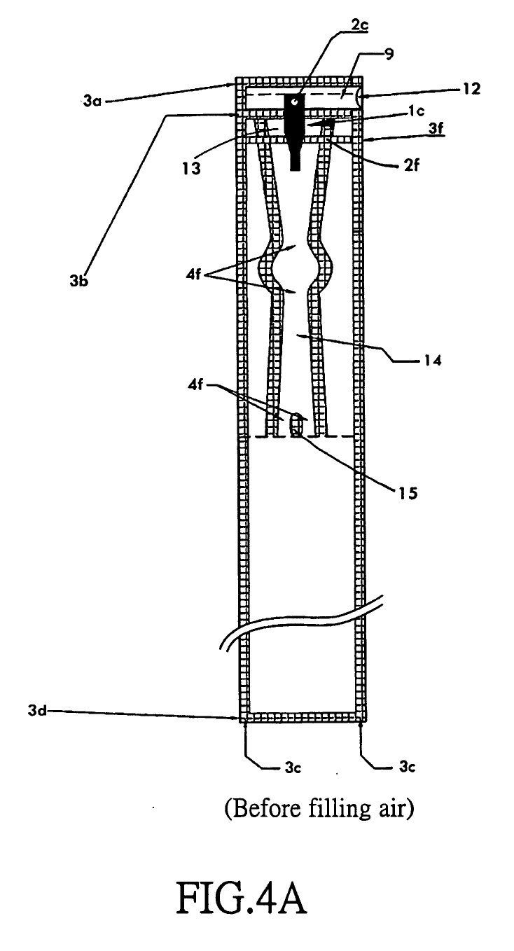

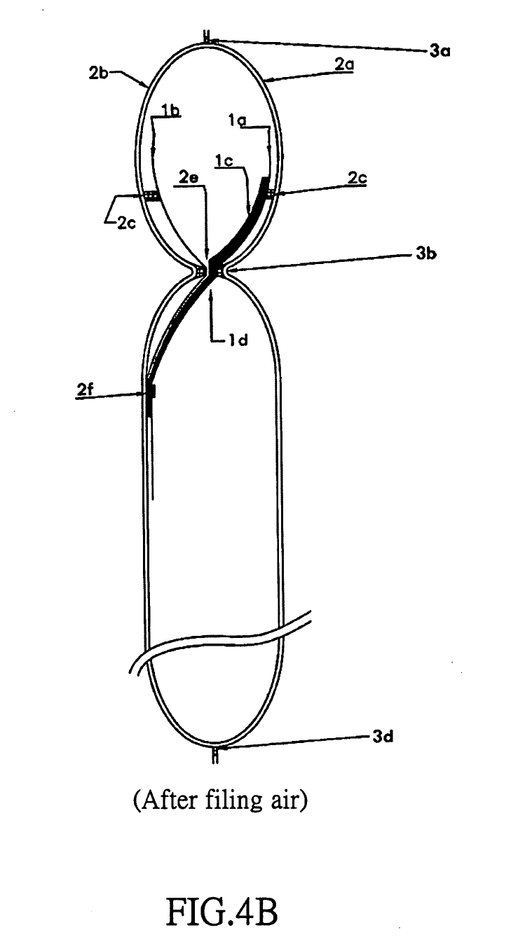

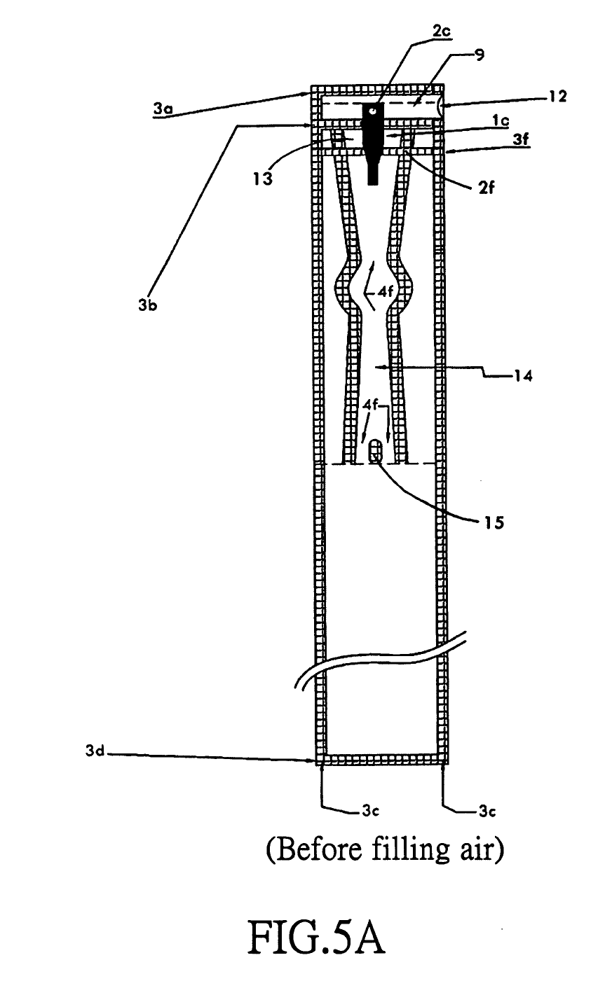

FIG. 4B is a sectional view illustrating the fifth embodiment of an air packing bag after being filled with the air;

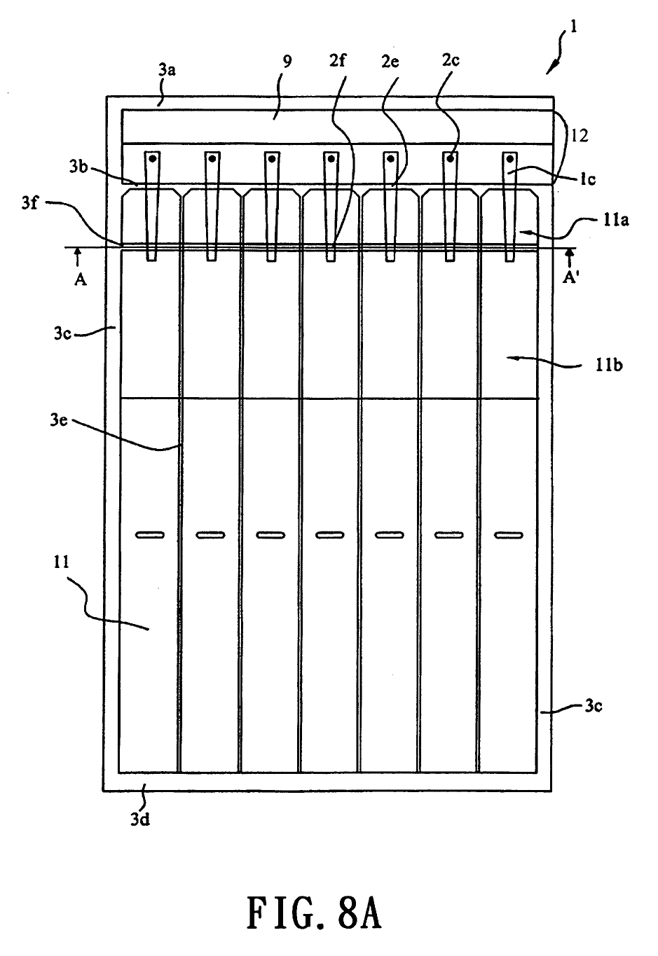

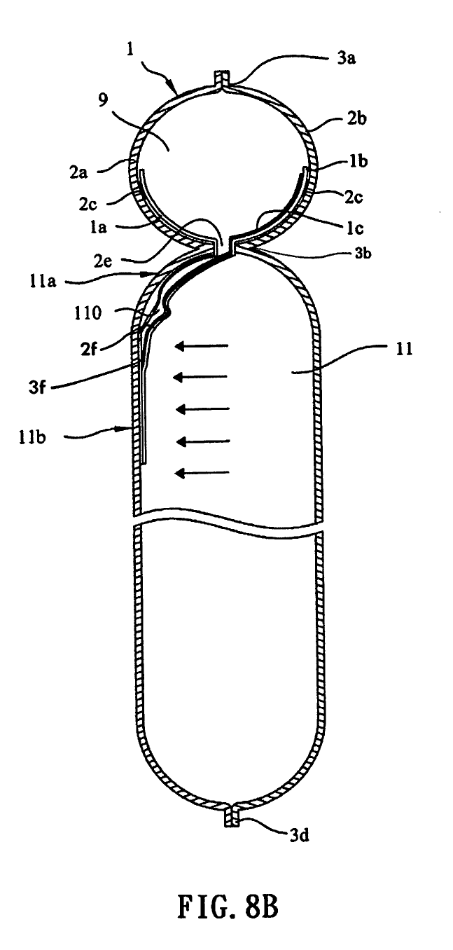

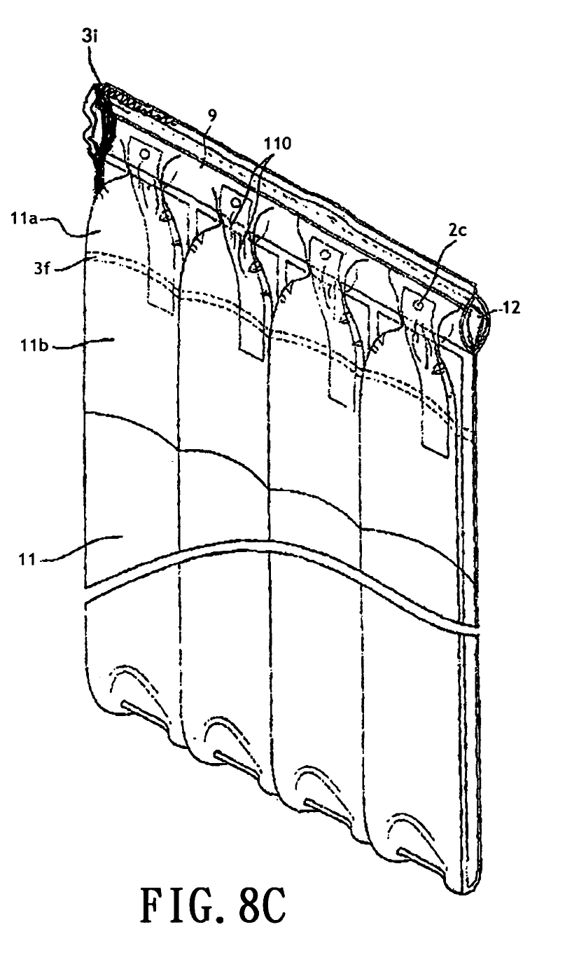

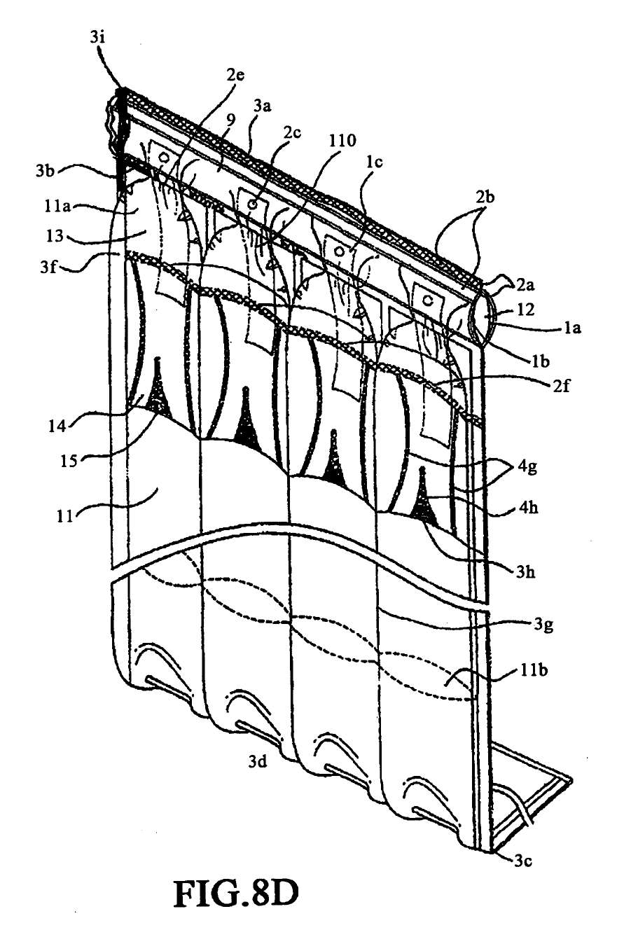

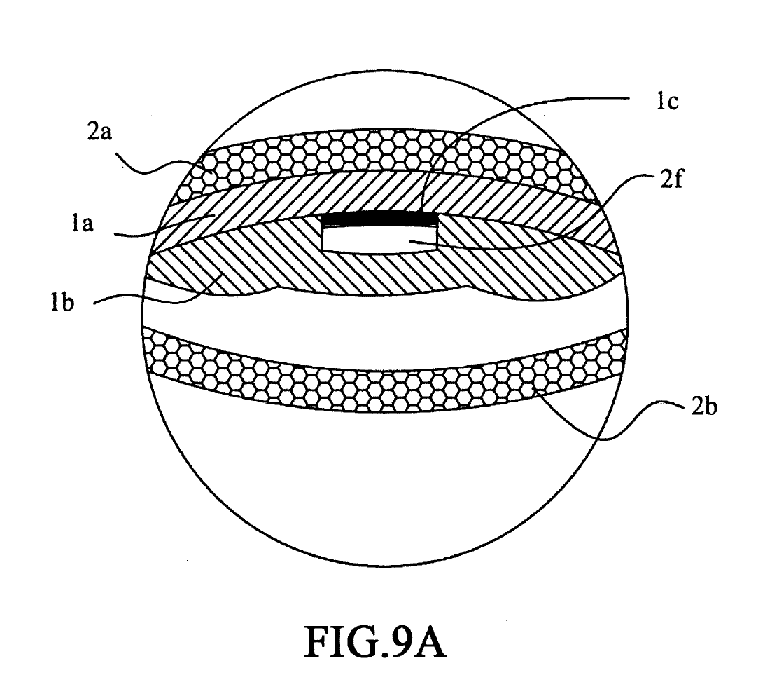

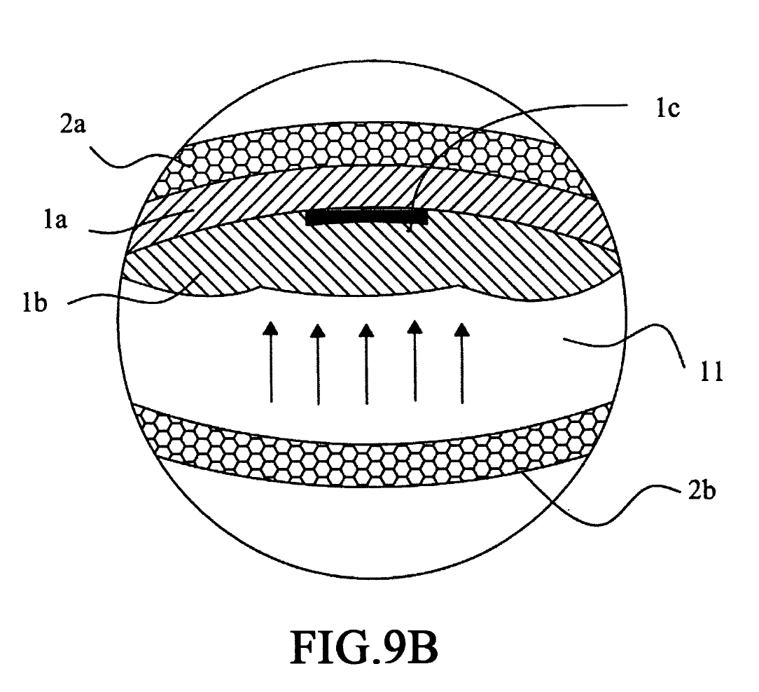

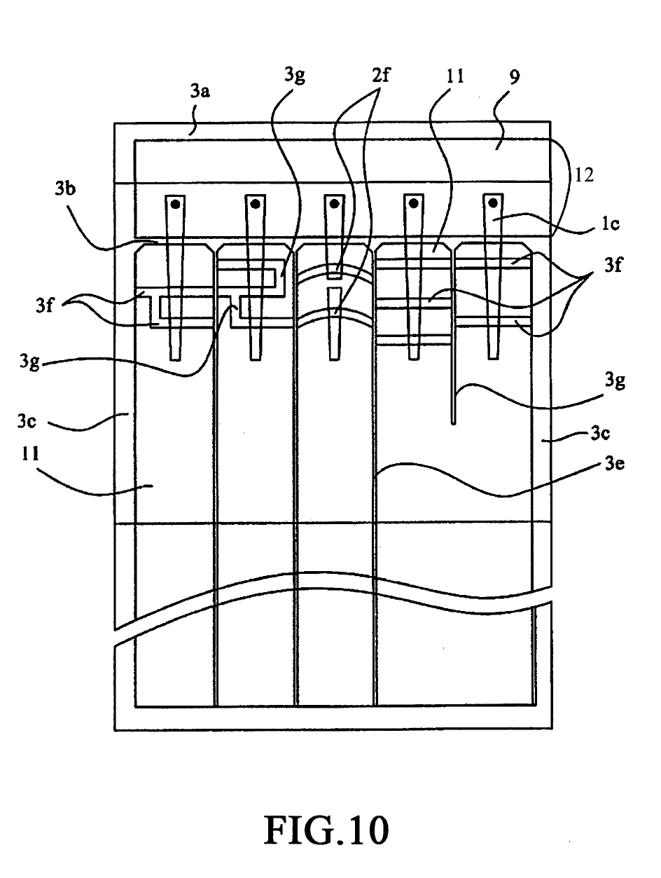

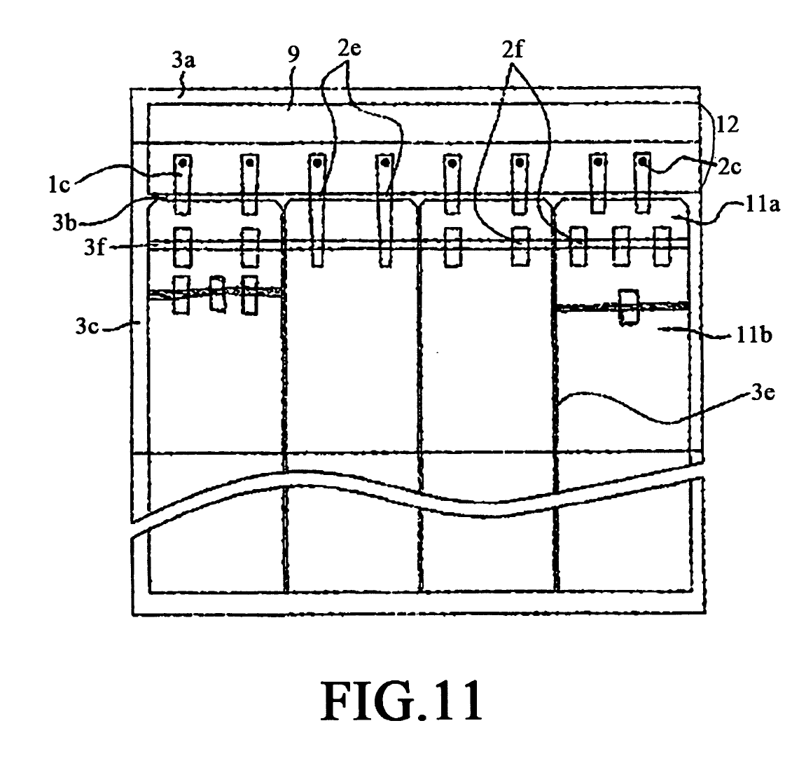

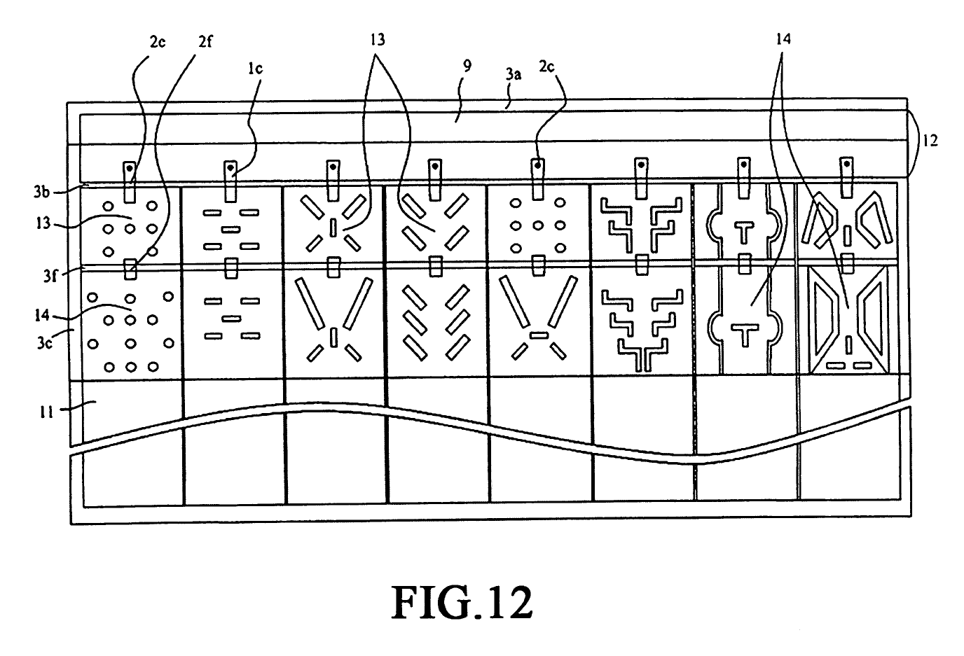

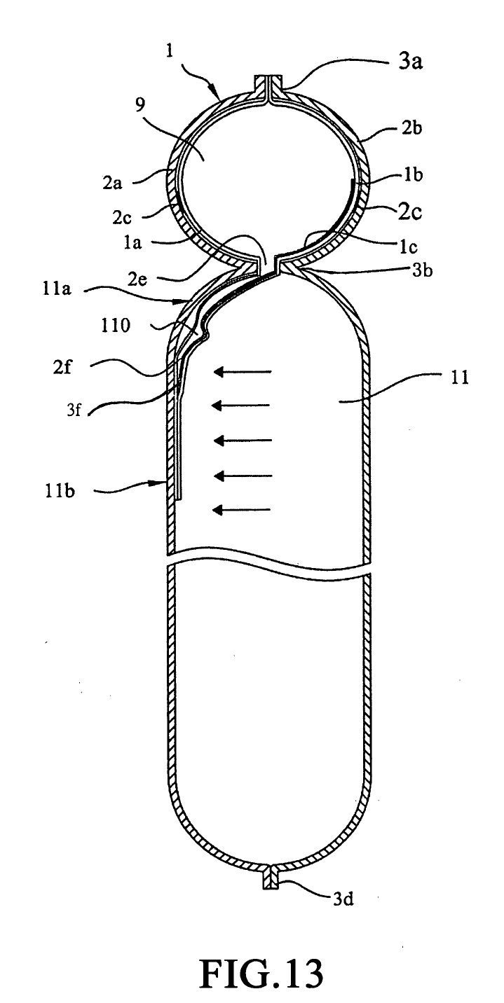

FIG. 8C is a perspective view of the first embodiment of an air sealing body according to the present invention after being filled with the air (without thermal sealing 4g, 4h);

FIG. 8D is a perspective view of the first embodiment of an air sealing body according to the present invention after being filled with the air (with thermal sealing 4g, 4h);

FIG. 9A is a sectional view along 1-1 of FIG. 8A illustrating the air sealing body of the present invention before being filled with the air;

FIG. 9B is a sectional view along 1-1 of FIG. 8A illustrating the air sealing body of the present invention after being filled with the air;

FIG. 10 is a plan view of the sixth embodiment of an air sealing body according to the present invention before being filled with the air;

FIG. 11 is a plan view of the seventh embodiment of an air sealing body according to the present invention before being filled with the air;

FIG. 12 is a plan view of the eighth embodiment of an air sealing body according to the present invention before being filled with the air; and

FIG. 13 is a sectional view illustrating the ninth embodiment of an air packing bag after being filled with the air.

### DETAILED DESCRIPTION OF THE INVENTION

Referring to FIGS. 4A and 4B, the first embodiment of an air sealing body capable of intensifying air-tightness according to the present invention is illustrated. An air sealing body includes two inner membranes 1a, 1b, which are oppositely disposed between two outer membranes 2a, 2b, and a heat resistant section 1c, which is made of heat resistant material, is arranged between the two inner membranes 1a, 1b. The implementation of the first embodiment of the air sealing body of the present invention is explained hereinafter.

The inner membranes 1a, 1b are overlaid to each other and thermally sealed with a ring-shaped thermal seal line 3f. Next, the inner membrane 1b is overlaid to the outer membrane 2b. Then, a second air channel 14 is formed by means of thermal sealing with several neck sections 4f being arranged to perform a function of choking. Further, the inner membrane 1b is overlaid to the outer membrane 2b and thermal seal lines 3a, 3b, 3c, 3d are provided at periphery of the outer membranes 2a, 2b. Under this circumference, the air sealing body of the present invention is divided into two zones, which are a filling channel zone 3a-3b and an air storage zone 3b-3d. The thermal seal lines 3c, 3d are thermal seal edges and the thermal seal line 3b is a border between the two zones 3a-3b, 3b-3d. Due to the heat resistant section 1c being made of heat resistant material, the inner membranes 1a, 1b are unable to adhere to each other in spite of the thermal sealing being performed via the thermal seal spots 2c to allow the inner membranes 1a, 1b being adhered to the outer membranes 2a, 2b respectively. The thermal seal line 3b is properly worked such that the inner membranes 1a, 1b at the thermal seal line 3b are not fixedly joined to each other and an inlet 2e is formed between the inner membranes 1a, 1b. When the air enters the air sealing body via the air passage 9 at the top of the air sealing body to expand the outer membranes 2a, 2b, the inlet 2e is able to open indirectly. Hence, the bent section 1d of the inner membranes 1a, 1b in the air storage zone 3b-3d is pressed by the increased air pressure after the air sealing body being filled with the air such that the inlet 2e is blocked with the inner membranes 1a, 1b to admit the coming air only and the outgoing air is incapable of moving out via the inlet 2e. Further, the increased internal pressure of the air storage zone 3b-3d urges the neck sections 4f of the second air channel 14 to block the passage of the second air channel 14. As a result, an air lock is formed accordingly.

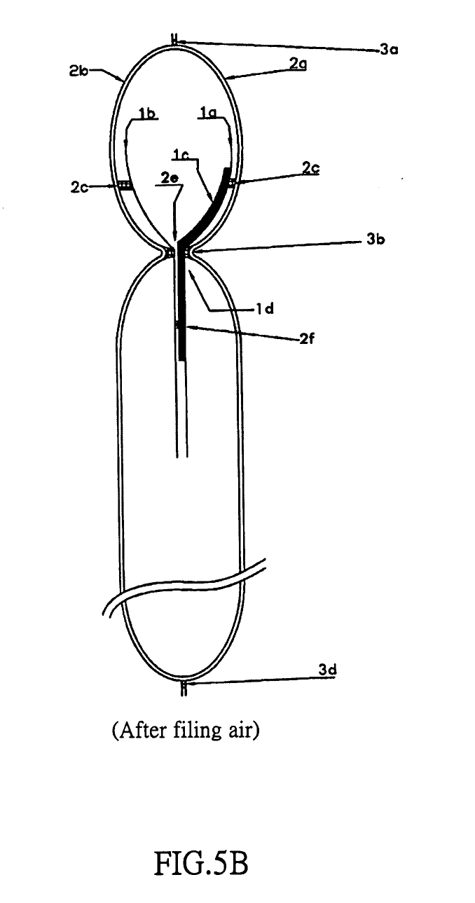

Referring to FIGS. 5A and 5B, the second embodiment of an air sealing body capable of intensifying air-tightness according to the present invention is illustrated. An air sealing body includes two inner membranes 1a, 1b, which are oppositely disposed between two outer membranes 2a, 2b, and a heat resistant section 1c, which is made of heat resistant material, is arranged between the two inner membranes 1a, 1b. The implementation of the second embodiment of the air sealing body of the present invention is explained hereinafter.

The inner membranes 1a, 1b are overlaid to each other and thermally sealed with a ring-shaped seal line 3f. Next, the inner membrane 1b is overlaid to the outer membrane 2b. Then, a second air channel 14 is formed by means of thermal sealing with several neck sections 4f being arranged to perform a function of choking. Further, the inner membranes 1a, 1b are disposed between the outer membranes 2a, 2b and thermal seal lines 3a, 3b, 3c, 3d are provided at periphery of the outer membranes 2a, 2b. Under this circumference, the air sealing body of the present invention is divided into two zones, which are a filling channel zone 3a-3b and an air storage zone 3b-3d. The thermal seal lines 3c, 3d are thermal seal edges and the thermal seal line 3b is a border between the two zones 3a-3b, 3b-3d. Due to the heat resistant knob 1c being made of heat-resisting material, the inner membranes 1a, 1b are unable to adhere to each other in spite of the thermal sealing being performed via the thermal sealing spots 2c to allow the inner membranes 1a, 1b being adhered to the outer membranes 2a, 2b respectively. The thermal seal line 3b is properly worked such that the inner membranes 1a, 1b at the thermal seal line 3b are not fixedly joined to each other and an inlet 2e is formed between the inner membranes 1a, 1b. When the air enters the air sealing body via the air passage 9 at the top of the air sealing body to expand the outer membranes 2a, 2b, the inlet 2e is able to open indirectly. Hence, after the air sealing body being filled with the air, the inlet 2e is blocked with the inner membranes 1a, 1b to admit the coming air only and the outgoing air is incapable of moving out via the inlet 2e. Further, the increased internal pressure at two side of the air storage zone 3b-3d urges the inner membranes 1a, 1b at the middle such that the neck sections 4f of the second air channel 14 can block the passage of the second air channel 14. As a result, an air lock is formed accordingly.

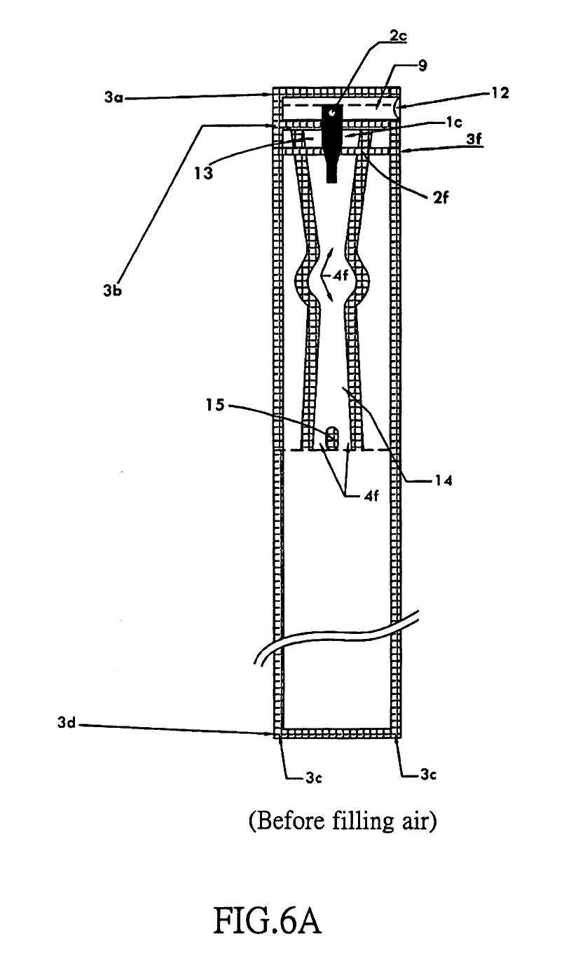

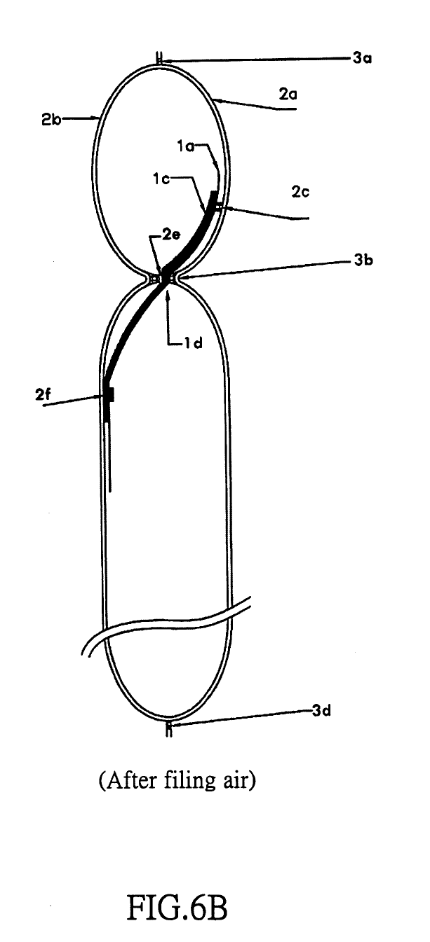

Referring to FIGS. 6A and 6B, the third embodiment of an air sealing body capable of intensifying air-tightness according to the present invention is illustrated. An air sealing body includes two outer membranes 2a, 2b, an inner membrane 1a and a heat resistant section 1c being coated on the inner membrane 1a. The inner membrane 1a is arranged between the two outer membranes 2a, 2b. The implementation of the third embodiment of the air sealing body of the present invention is explained hereinafter.

The inner membrane 1a is overlaid to the outer membrane 2b and thermally sealed with a ring-shaped seal line 3f. Next, the inner membrane 1b is overlaid to the outer membrane 2b. Then, a second air channel 14 is formed under the heat resistant section 1c by means of thermal sealing with several neck sections 4f being arranged to perform a function of choking. Further, the inner membrane 1b is overlaid to the outer membrane 2a and thermal seal lines 3a, 3b, 3c, 3d are provided at periphery of the outer membranes 2a, 2b. Under this circumference, the air sealing body of the present invention is divided into two zones, which are a filling channel zone 3a-3b and an air storage zone 3b-3d. The thermal seal lines 3c, 3d are thermal seal edges and the thermal seal line 3b is a border between the two zones 3a-3b, 3b-3d. Due to the heat resistant section 1c being made of heat resistant material, the inner membrane 1a is unable to adhere to the outer membrane 2b in spite of the inner membrane 1a being thermally sealed to the outer membrane 1a via the thermal seal spot 2c to allow the inner membranes 1a closely touching the outer membrane 2a. The thermal seal line 3b is properly worked such that the inner membrane 1a at the thermal seal line 3b is not fixedly joined to the outer membrane 2b so as to form an inlet 2e between the inner membrane 1a and the outer membrane 2b. When the air enters the air sealing body via the air filling passage 9 at the top of the air sealing body to expand the outer membranes 2a, 2b, the inlet 2e is able to open indirectly. Hence, the bent section 1d of the inner membrane 1a in the air storage zone 3b-3d is pressed by the increased air pressure after the air sealing body being filled with the air such that the inlet 2e is blocked with the inner membrane 1a to admit the coming air only and the outgoing air is incapable of moving out via the inlet 2e. Further, the increased internal pressure of the air storage zone 3b-3d urges the inner membrane 1a to closely touch the outer membrane 2b such that the neck sections 4f of the second air channel 14 can block the passage of the second air channel 14. As a result, an air lock is formed accordingly.

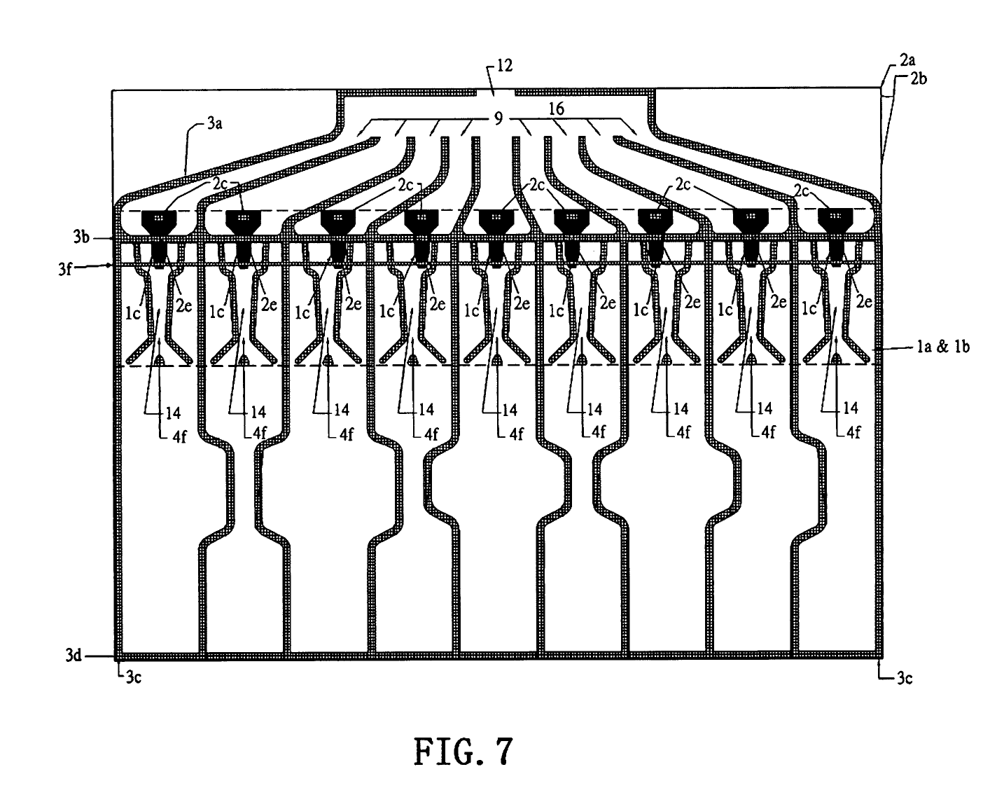

Referring to FIG. 7, the fourth embodiment of an air sealing body capable of intensifying air-tightness according to the present invention is illustrated to provide an air collecting well, which is composed of a plurality of air sealing bodies. Each air sealing body includes two outer membranes 2a, 2b, an inner membrane 1a, which is coated with a heat resistant section 1c, and another membrane 1b without being coated with the heat resistant section 1c.

The inner membranes 1a, 1b are disposed between the outer membranes 2a, 2b, and the heat resistant section 1c is disposed between the two inner membranes 1a, 1b. The implementation of the fourth embodiment of each air sealing body of the present invention is explained hereinafter.

Due to the heat resistant section 1c being made of heat resistant material, the inner membranes 1a, 1b are unable to adhere to each other in spite of the thermal sealing being performed via the thermal seal spots 2c to allow the inner membranes 1a, 1b being adhered to the outer membranes 2a, 2b respectively for the outer membranes 2a, 2b being capable of expanding the inner membranes 1a, 1b while the air being filled. The inner membranes 1a, 1b are overlaid to each other and thermally sealed with a ring-shaped seal line 3f. Next, the inner membrane 1b is overlaid to the outer membrane 2b. Then, a second air channel 14 is formed below the heat resistant section 1c by means of thermal sealing with several neck sections 4f being obtained at the second air channel 14. Further, thermal seal lines 3a, 3b, 3c, 3d are provided at periphery of the outer membranes 2a, 2b to divide the air sealing body into two zones, a filling channel zone 3a-3b and an air storage zone 3b-3d. The thermal seal lines 3c, 3d are thermal seal edges and the thermal seal line 3b is a border between the two zones 3a-3b, 3b-3d. Due to the heat resistant section 1c being made of heat-resisting material, the inner membranes 1a, 1b are unable to adhere to each other and constitute an opening. The air being filled to all the air sealing bodies needs longer time. In order to shorten the air filling time, an air collecting well 16 with branch channels 9 is provided to communicate with the single filling mouth 12. The branch channels 9 are fabricated with by means of thermal pressing to act as direct passages of the air sealing bodies respectively. The air gathers at the air collecting well 16 via the air filling mouth 12 and the air at the air collecting well 16 enters the inlet of the respective air sealing body. In this way, the air filling time can be shortened substantively. It is noted the inner membrane arrangement of the present invention is the same as the embodiments illustrated in FIGS. 4A and 4B, FIGS. 5A and 5B and FIGS. 6A and 6B so that no details are recited further.

Referring to FIGS. 8A to 8D, the fifth embodiment of an air sealing body capable of intensifying air-tightness according to the present invention is illustrated.

It can be seen in FIGS. 8A to 8D, the air sealing body of the present invention includes two outer membranes 2a, 2b, two inner membranes 1a, 1b and a heat resistant material 1c, which is coated on a side of the respective inner membrane 1a, 1b in advance. The inner membranes 1a, 1b are overlaid to each other with the heat resistant material 1c being disposed between the inner membranes 1a, 1b and are thermally sealed with a ring-shaped seal line 3f. Then, the inner membrane 1a is thermally sealed to the outer membrane 2a with a seal line 3g to form an air passage and with another seal line 3h to form an outlet of the air passage. Further, the outer membranes 2a, 2b are thermally sealed to form a seal line 3a at the top ends thereof. A seal line 3b and a seal spot 2c are thermally formed at the outer membranes 2a, 2b and about the middle of the heat resistant material 1c such that the outer membranes 2a, 2b at an area between the seal lines 3a and 3b constitute an air filling passage 9 and an air filling mouth 12 at an end of the air filling passage 9. Another end of the air filing passage 9 is thermally formed a seal line 3i. Due to the heat resistant material 1c being coated on a side of the respective inner membrane 1a, 1b and being interposed between the inner membranes 1a, 1b, the inner membranes 1a, 1b are incapable of adhering to each other. The outer sides of the inner membranes 1a, 1b are attached to the outer membranes 2a, 2b respectively. The seal line 3b forms a first inlet 2e in addition to the air filling passage 9 and an air storage zone 3b-3d is formed between the seal line 3b and the seal line 3d at the bottom of the outer membranes 2a, 2b. A vertical seal line 3c is thermally formed at two opposite lateral sides of the air sealing body between the seal line 3b and the seal line 3d. A plurality of containing columns 11 are formed independently.

When the air is filled, the air enters the air sealing body 1 from the air filing mouth 12 along the filling passage 9 such that the outer membranes 2a, 2b expand to detach the inner membrane 1a from the inner membrane 1b due to the seal spots 2c thermally joining the inner membrane 1a and the outer membrane 2a, and the inner membrane 1b and the outer membrane 2b respectively and the heat resistant material 1c between the inner membranes 1a, 1b. Under this circumference, the first inlet 2e opens automatically to admit the air entering the zone between the seal line 3b and the seal line 3f such that a second inlet 2f opens to admit the air to move along a preset path 14 and then an outlet seal spot 15 admits the air to expand the containing columns 11, which are flat originally. As a result, the containing columns 11 bulges from the seal line 3b to become a shape of cylinder such that the zone between the seal line 3b and the seal line 3f has a natural contraction ratio “π” and the zone between the seal line 3a and the seal line 3b produces a plurality of wrinkles, which are caused by the natural contraction ratio.

After the air entering the air column 11 via the second inlet 2f, the wrinkles at the zone 3a-3b of the outer surfaces of the cylinder-shaped containing columns 11 are disappeared. Because the seal line 3f is formed at the time of the two inner membranes being thermal sealed together, the outer membranes 2a, 2b are not thermally adhered to the seal line 3f. Hence, the zone between 3b and 3f is an inclining curve and the air paths 4g, 4h from the second inlet 2f and the seal line 3f are turning points of the surface 3b changing to the cylindrical smooth surface from a curved surface. A preset air path 14 and the seal line 4h are formed from the seal line 3g such that the outlet seal spot 15 is created for the inner membranes 1a, 1b under the seal line 3f being filled with the air and urging the zone 3b-3f-3h while the air column 11 is fully filled with the air and the inner membranes 1a, 1b closely contact one of the outer membranes 2a, 2b to reserve a zone 3a-3b-3f at the naturally contracted wrinkled zone. As a result, the wrinkles are urged by the air pressure naturally instead of being an air path. The smoothly cylindrical air column 11 at the part below the second inlet 2f has sealed scar-marks projecting from the surface of the air column 11 and the sealed scar-marks are suppressed by the air pressure in the air column 11 first. That is, the ring-shaped seal line 3f is pressed first if the inner membranes 1a, 1b are looked from the inner side of the air column 11. Thus, the second inlet 2f shuts closely and the seal lines 4g, 4h allows the air path 14 being urged to suppress the inner membranes 1a, 1b at the ring-shaped seal line 3f such that the air flow is blocked completely and the air flowing inversely is impossible to pass through and air-tightness can be intensified effectively.

As the foregoing, the present invention discloses that the inner membranes 1a, 1b are joined by means of thermal sealing to form a seal line 3f and the second inlet 2f is formed at intersection of the ring-shaped seal line 3f and the heat resistant material 1c.

The air entering via the air filling mouth 12 expands the air filling passage 9 to detach the inner membrane 1a from the inner membrane 1b so as to open the first inlet 2e. When the air passes through the first inlet 2e and enters a space between the inner membranes 1a, 1b, the second inlet 2f opens automatically such that the air can be filled into the respective air column 11 and expend the respective air column 11 via the second inlet 2f sequentially.

Each of the containing columns 11 provides a curved surface zone 11a near the air filling passage 9 after the containing columns 11 have been expanded with fully filled air. The curved surface zone 11a originates from a flat surface to rise as an arc shape and then becomes a cylindrical shape like a spherical surface. There is a natural contraction ratio “π” while the flat surface changing to the cylindrical surface such that a plurality of wrinkles appear on the curved surface zone 11a although the air in the respective air column 11 forcedly presses the inner membranes 1a, 1b at the curved surface zone 11a and to adhere one of the outer membranes 2a, 2b for covering the first inlet 2e. Further, there are many wrinkles 110 being formed at the inner membranes 1a, 1b due to the inner membranes 1a, 1b being unable to adhere one of the outer membranes 2a, 2b flatly. Under this circumference, the wrinkles 110 offer fine seams for the air in each air column 11 being able to flow inversely.

A column surface zone 11b disposed next to the curved surface zone 11a provides a cylindrical shape. The air in the respective air column 11 presses the inner membranes 1a, 1b at the column surface 11b such that the inner membranes 1a, 1b flatly adhere one of the outer membranes 2a, 2b so as to cover the second inlet 2f and stop the air at the wrinkles 110 of the curved surface zone 11a to leak outward inversely. In this way, effect of air-tightness can be attained significantly.

Furthermore, the ring-shaped seal line 3f can be disposed between the curved surface zone 11a and the column surface zone 11b or in the area of the column surface zone 11b instead of being in the area of the curved surface zone 11a.

Besides, the ring-shaped seal line 3f can be thermally joined to one of the outer membranes 2a, 2b and the inner membranes 1a, 1b instead of being joined to the inner membranes 1a, 1b only.

Referring to FIGS. 9A and 9B, a state prior to the air being filled and a state after the air being filled of the fifth embodiment of an air sealing body capable of intensifying air-tightness according to the present invention are illustrated. Because the ring-shaped seal line 3f is thermally joined to the inner membranes 1a, 1b, thickness of the ring-shaped sealing line 3f is greater than the thicknesses of the inner membranes 1a, 1b and an elevation difference is formed between the second inlet 2f and the ring-shaped seal line 3f. When the respective air column 11 expands, the air therein presses the inner membranes 1a, 1b to block the first inlet 2e and the second inlet 2f so that it is not possible for the air to leak outward from the wrinkles 110 at the curved surface zone 11a. In this way, life span of the air sealing body 1 can be extended in addition to the effect of the air-tightness.

Referring to FIG. 10, the sixth embodiment of an air sealing body capable of intensifying air-tightness according to the present invention is illustrated. A plurality of ring-shaped seal lines 3f are formed at the time of the inner membranes 1a, 1b being thermally joined and the second inlet 2f is formed at intersection of each of the ring-shaped sealing lines and the heat resistant material 1c. A partition line 3g can be provided between the ring-shaped thermal sealing lines 3f such that the ring-shaped thermal sealing lines 3f are able to pass through the partition line 3g for separating the containing columns 11 in sections instead of a ring-shaped thermal seal line 3f joining the thermal seal line 3e at two lateral sides of the respective air column 3e.

Further, the inner membranes 1a, 1b can be coated with the heat resistant material 1c from the air filling passage 9 and the heat resistant material 1c pierces the thermal seal line 3b and the ring-shaped thermal seal lines 3f. Alternatively, the way of coating the heat resistant material 1c can be performed separately. That is, the heat resistant material 1c, which is coated at the thermal seal line 3b, passes through the thermal seal line 3b and then is coated at the respective ring-shaped thermal seal line 3f and passes through the respective ring-shaped thermal seal line 3f.

Referring to FIG. 11, the seventh embodiment of an air sealing body capable of intensifying air-tightness according to the present invention is illustrated. The heat resistant material 1c is coated on the inner membrane 1a from a position different from that the heat resistant material 1c is coated on the inner membrane 1b such that a plurality of first inlets 2e and second inlets 2f are formed to correspond to each other. Alternatively, the heat resistant material 1c can be separately coated, that is, the heat resistant material 1c can be coated at different positions of the thermal sealing line 3b to form a plurality of first inlets 2e and at different positions of the ring-shaped thermal seal line 3f to form a plurality of second inlets 2f in a way of the first inlets 2e corresponding to or not corresponding to the second inlets 2f respectively.

Referring to FIG. 12, the eighth embodiment of an air sealing body capable of intensifying air-tightness according to the present invention is illustrated. The difference of the eighth embodiment of the present invention from the preceding embodiments is in that a first air path 13 and the second air path 14 are further provided. The first air path 13 connects with the first inlet 2e and is formed at the inner membranes 1a, 1b by means of thermal sealing. The second air path 14 connects with the second inlet 2f and is formed between the inner membranes 1a, 1b by means of thermal sealing.

Besides, the first air path 13 and the second air path 14 can be designed to adjust the moving line of the air such that it is for the air passing through the first air path 13 and the second air path 14 easily but it is difficult for the air to flow outward inversely. In case of the first air path 13 having a larger end to connect with the first inlet 2e and the air pressure of the first air path 13 at the curved surface zone being greater than that at column surface zone, it is easy for the air to enter the sealing body via the first inlet 2e and it is difficult for the air to exit the sealing body via the first inlet 2e such that the air presses the curved part of the first air path 13 to obtain the effect of air-tightness while the internal pressure of the air column 11 increases. If the second air path 14 is designed with the same structure as the first air path 13, the same effect can be obtained as well.

Referring to FIG. 13, the ninth embodiment of an air sealing body capable of intensifying air-tightness according to the present invention is illustrated. The difference of the ninth embodiment from the preceding embodiments is in that the top end sides and the lower end sides of the inner membranes 1a, 1b coincide with the top end sides and the lower end sides of the outer membranes 2a, 2b such that the inner membranes 1a, 1b are joined to the outer membranes 2a, 2b with the thermal seals 3a, 3b and the filling passage 9 is formed between the inner membranes 1a, 1b.

It is appreciated that an air sealing body capable of intensifying air-tightness according to the present invention provides a plurality of containing columns 11, which each have a curved surface zone 11a and a column surface zone 11b with a ring-shaped thermal seal line 3f between the curved surface zone 11a and the column surface zone 11b after the air sealing body is fully filled with air, such that the inner membranes 1a, 1b is forcedly pressed by the air to block the first inlet 2e and the second inlet 2f and effect of air-tightness for the air column 11 is enhanced significantly to prevent the air from moving outward inversely via the wrinkles 110 and to prolong the life span of the air sealing body 1 effectively.

While the invention has been described with referencing to preferred embodiments thereof, it is to be understood that modifications or variations may be easily made without departing from the spirit of this invention, which is defined by the appended claims.

What is claimed is:

1. An air sealing body capable of intensifying air-tightness comprising:
two outer membranes providing a top thermal seal line;
two inner membranes with one of said inner membranes being coated with slightly adhesive agent for adhering said two inner membranes to each other, being disposed between said two outer membranes, being thermally joined to said outer membranes respectively with a heat resistant material being coated on the inner side of the respective inner membrane to form a heat resistant section;
at least a thermal seal spot being thermally sealed to said heat resistant section from said outer membranes respectively to allow said inner membranes being adhered to the outer membranes such that said outer membranes expand to forcedly detach said inner membranes from each other during the air being filled;
an air filling passage being disposed between the thermal seal line crossing said heat resistant section and said top thermal seal line;
at least a first inlet being formed between said inner membranes and at the thermal seal line crossing said heat resistant section due to said heat resistant section allowing said inner membranes not adhering to each other and providing an opening for admitting the air;
at least an air column being disposed below the thermal seal line crossing said heat resistant section and being formed with the periphery being thermally sealed for air storage;
a curved surface zone being disposed on said air column next to said air filling passage for the air in said air column pressing said inner membranes to adhere one of said outer membranes such that a plurality of wrinkles are produced between said inner membranes;
a column surface zone being disposed next to said curved surface zone for the air in said air column pressing said inner membranes to adhere one of said outer membranes flatly;
at least a ring-shaped thermal seal line being thermally formed to join to at least said inner membranes through said heat resistant section and being disposed at said curved surface zone next to said column surface zone; and
at least a second inlet being thermally formed between said inner membranes through said heat resistant section and being disposed at an intersection of said heat resistant section and said ring-shaped thermal sealing line for communicating a lower portion and an upper portion of said containing column.

2. The air sealing body capable of intensifying air-tightness as defined in claim 1 further comprises at least a set of first air paths, which are in said air column and connects with said first inlet between said inner membranes.

3. The air sealing body capable of intensifying air-tightness as defined in claim 1 further comprises at least a second air path, which is in said air column connects with said second inlet between said inner membranes.

4. The air sealing body capable of intensifying air-tightness as defined in claim 1, wherein said ring-shaped thermal seal line is disposed at a border between said curved surface zone and said column surface zone or in said column surface zone and said ring-shaped thermal seal line is joined to said inner membranes via said heat resistant section or is joined to one of said outer membranes and said inner membranes via said heat resistant section.

5. The air sealing body capable of intensifying air-tightness as defined in claim 1, wherein said second inlet is disposed at an elevation different from said ring-shaped thermal seal line such that the air in said air column presses said inner membranes to urge said second inlet such that said air column is blocked.

6. The air sealing body capable of intensifying air-tightness as defined in claim 1, wherein one of the inner membranes provides a plurality of heat resistant sections, which are made of heat resistant material and equally space from one another, at the top of the inner side thereof and the outer membranes provide a thermal seal spot and a thermal seal line respectively at the same elevation of the heat resistant sections; said thermal seal line divides said air column into a filling channel zone and an air storage zone; a first inlet, which is formed between the inner membranes due to the heat resistant sections allowing the inner membranes not adhering to each other, and an air filling mouth communicating with said first inlet are provided; a thermal seal spot is provided at the inner membranes on top of said heat resistant sections respectively for the inner membranes thermally joining with said outer membranes respectively such that when the air is filled into the air sealing body via said air filling passage, the outer membranes expand and detach said inner membranes from each other to open said first inlet indirectly of said air column.

7. The air sealing body capable of intensifying air-tightness as defined in claim 1, wherein an air path with a plurality of small easily blocked neck sections is formed thermally to have a shape of being wide at the top and the bottom thereof and narrow at the middle thereof or to have cross forming lines for the air being able to pass through in a way of surrounding a cross opening at said inner membranes independently and then is placed below the respective heat resistant section or is formed thermally at said inner membranes with one of said outer membranes and then is placed below the respective heat resistant section before said inner membranes being overlaid and thermally sealed to the said outer membranes such that an air path is constituted corresponding to said air column and an inlet is constitute at the position of the respective heat resistant section.

8. A check valve device capable of intensifying air-tightness being mounted to at least an air column, which is formed with two outer membranes being thermally sealed to provide an air filling passage for being filled and expanded with air, comprising:
two inner membranes being disposed between said two outer membranes with heat resistant material in between and said heat resistant material being coated on the inner side of respective inner membrane;
at least a first inlet being formed between said inner membranes with thermal sealing for admitting air passing through said air filling passage;
a curved surface zone being disposed on said air column next to said air filling passage for the air in said air column pressing said inner membranes to adhere one of said outer membranes such that a plurality of wrinkles are produced between said inner membranes;
a column surface zone being disposed next to said curved surface zone for the air in said air column pressing said inner membranes to adhere one of said outer membranes flatly;
at least a ring-shaped thermal seal line being thermally formed to join said inner membranes and being located at said curved surface zone next to said column surface zone; and
at least a second inlet being thermally formed between said inner membranes and being disposed at a position of a second heat resistant band formed by said heat resistant material intersecting said ring-shaped thermal seal line for communicating a lower portion and an upper portion of said containing column.

9. The check valve device capable of intensifying air-tightness as defined in claim 8 further comprises at least a first air path, which connects with said first inlet and is formed with thermal sealing between said inner membranes.

10. The check valve device capable of intensifying air-tightness as defined in claim 8 further comprises at least a second air path, which connects with said second inlet formed by said second heat resistant band and is formed with thermal sealing between said inner membranes.

11. The check valve device capable of intensifying air-tightness as defined in claim 8, wherein said thermal seal line is disposed at either a border of said heat resistant section of said curved surface zone next to said column surface zone or in said column zone and said thermal seal line is thermally joined to either said inner membranes or one of said outer membranes and said inner membranes.

12. The check valve device capable of intensifying air-tightness as defined in claim 8, wherein said second inlet is disposed at an elevation different from said thermal seal line such that the air in said air column presses said inner membranes to block said second inlet.

13. The check valve device capable of intensifying air-tightness as defined in claim 8, wherein said air column receives air, mixture of air-vapor or liquid entering via said filling passage and said liquid in said air column is refrigerated as a medium for cold storage.

14. The check valve device capable of intensifying air-tightness as defined in claim 8, wherein at least a heat resistant band with a ring-shaped thermal seal line is provided in said air column to divide said air column into an upper-half part, a heat resistant band and a lower-half part with a plurality of heat resistant sections corresponding to a plurality of ring-shaped thermal seal line so as to constitute one said first inlet at the upper-half part and a plurality of said second inlet at the lower-half part.

15. The check valve device capable of intensifying air-tightness as defined in claim 8, wherein said two inner membranes provide at least a heat resistant section and a heat resistant thermal spot on top of said heat resistant section; and said thermal seal spot provides a shape of circle, triangle, a short line or two parallel lines.

16. The check valve device capable of intensifying air-tightness as defined in claim 8, wherein said air filling passage is formed with two thermal horizontal seal lines and one of two ends of said air filling passage is thermally sealed to leave a horizontal air filling mouth; or the upper one of said thermal horizontal seal lines is opened an vertical air filling mouth and both of said two ends are sealed.
